(19) United States
(12) Patent Application Publication
(10) Pub. No.: US 2016/0140303 A1
(43) Pub. Date: May 19, 2016

(54) VALUE-BASED HEALTH CARE MANAGEMENT SYSTEMS AND METHODS

(71) Applicant: THE REGENTS OF THE UNIVERSITY OF CALIFORNIA, Oakland, CA (US)

(72) Inventors: Eric Esrailian, Beverly Hills, CA (US); Daniel W. Hommes, Los Angeles, CA (US)

(73) Assignee: THE REGENTS OF THE UNIVERSITY OF CALIFORNIA, Oakland, CA (US)

(21) Appl. No.: 14/941,490

(22) Filed: Nov. 13, 2015

Related U.S. Application Data
(63) Continuation of application No. PCT/US2014/038235, filed on May 15, 2014.
(60) Provisional application No. 61/823,811, filed on May 15, 2013.

(51) Int. Cl. G06F 19/00; G06F 3/0484

(52) U.S. Cl. CPC G06F 19/328; G06F 19/322; G06F 19/363; G06F 19/366; G06F 3/0484

(57) ABSTRACT

A system and method are disclosed for management of patient care and research using a combination of value-based methodology and translational research methodology. The system includes software to generate a single outcome measurement, or “Value-Quotient (VQ)” expressing a delivered health value and the associated costs. The software may also include a user interface to generate and manage coordinated care pathways (i.e. tight control scenarios) aimed at complication prevention and disease control. The software also may include functionality for direct task differentiation for provider teams, shifting work load from physicians to trained nurses and administration.

### CROSS-REFERENCE TO RELATED APPLICATIONS

This application is a 35 U.S.C. §111(a) continuation of PCT international application number PCT/US2014/038235 filed on May 15, 2014, incorporated herein by reference in its entirety, which claims priority to, and the benefit of, U.S. provisional patent application Ser. No. 61/823,811 filed on May 15, 2013, incorporated herein by reference in its entirety. Priority is claimed to each of the foregoing applications.

The above-referenced PCT international application was published as PCT International Publication No. WO 2014/186598 on Nov. 20, 2014, which publication is incorporated herein by reference in its entirety.

### STATEMENT REGARDING FEDERALLY SPONSORED RESEARCH OR DEVELOPMENT

Not Applicable

### INCORPORATION-BY-REFERENCE OF COMPUTER PROGRAM APPENDIX

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND

1. Technical Field

This description pertains generally to health care management, and more particularly to systems and methods for value-based health care management.

2. Background Discussion

Health care spending is unsustainable, and many people lack adequate health coverage. Despite high spending, U.S. health outcomes are poor, and health disparities exist among numerous populations. Often, the current system emphasizes treatment instead of prevention.

Transformational change is needed, but solutions embracing the entire complexity of care are lacking. Value-based methodology has been introduced as an abstract concept, but no systematic method or system for implementation is available.

### BRIEF SUMMARY

An aspect of the disclosure is a system and methods for management of patient care and research using a combination of value-based methodology and translational research methodology.

By way of example, and not of limitation, the systems and methods of the present description generate a single outcome measurement of a Value-Quotient (VQ) that correlates delivered health value and the associated costs.

Another aspect is a health management system and method that builds and manages coordinated care pathways (i.e. tight control scenarios) configured for complication prevention and disease control.

Another aspect is a health management system and method that directs task differentiation for provider teams shifting work load from physicians to trained nurses and administration.

Another aspect is a health management system and method that builds and manages value-based insurance to allow quality payment.

Another aspect is a health management system and method that manages home care, patient participatory eHealth programs offering education, training, mental support, job coaching and rebates for levels of participation.

Another aspect is a health management system and method that Integrates translational research methodology with care delivery.

Further aspects of the description will be brought out in the following portions of the specification, wherein the detailed description is for the purpose of fully disclosing preferred embodiments of the description without placing limitations thereon.

### BRIEF DESCRIPTION OF THE SEVERAL VIEWS OF THE DRAWING(S)

The description will be more fully understood by reference to the following drawings which are for illustrative purposes only:

FIG. 1 is a schematic diagram illustrating the general architecture of a healthcare system of the present disclosure.

FIG. 2 is a schematic flow diagram of the system of FIG. 1 with the biobanking component of the VQ program turned on.

FIG. 3 shows an exemplary macro diagram of TC infrastructure components.

FIG. 4A and FIG. 4B show a schematic diagram of a graphical user interface and decision flow chart of the TC infrastructure.

FIG. 5A and FIG. 5B show an exemplary screen view of a patient dashboard that may be implemented at a patient interface in accordance with the present disclosure.

FIG. 6 shows an exemplary screen view of a daily clinical practice dashboard that may be implemented at a physician interface in accordance with the present disclosure.

FIG. 7 shows a schematic diagram of typical segmented care.

FIG. 8 shows a schematic diagram of a tight control care program in accordance with the present disclosure having an organized and coordinated care pathway.

FIG. 9A and FIG. 9B show schematic diagrams of tight control scenarios for mild disease and severe disease cases respectively.

FIG. 10 illustrates a schematic diagram of an exemplary care scenario for a clinic visit in accordance with the present disclosure.

FIG. 11 shows a schematic diagram of a work up scenario and corresponding selection of tight control scenario.

FIG. 12 shows a schematic diagram of an exemplary remission induction tight control scenario.

FIG. 13 is a schematic diagram of an exemplary maintenance tight control scenario.

FIG. 14 shows a diagram of an overview of the tight control scenario for testing VQ's in accordance with the present disclosure.

FIG. 15A and FIG. 15B are plots of VQ performance in active patients entering the remission induction (5ASA) scenario.

FIG. 16A and FIG. 16B are plots of VQ performance in active patients entering the remission induction (steroid) scenario.

FIG. 17A and FIG. 17B are plots of VQ performance in active patients entering the remission induction (biologics) scenario.

FIG. 18 is a plot of VQ performance in remissive patients in maintenance scenarios.

FIG. 19 illustrates an exemplary block diagram of a health care management system on which the exemplary healthcare management methods of the described embodiments may operate.

### DETAILED DESCRIPTION

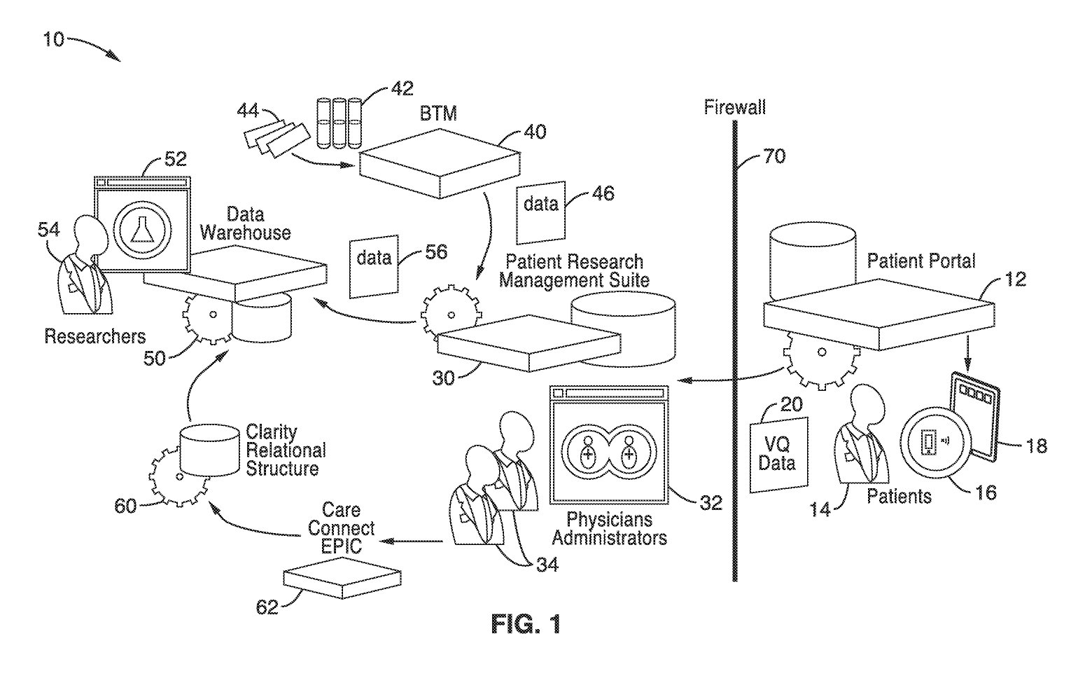

FIG. 1 is a schematic diagram illustrating the general architecture of healthcare system 10 of the present disclosure, showing the interaction between the patient research management suite 30 (VQ system) and patient portal 12. The patient portal 12 interfaces with patients 14 via patient interface software 16 on one or more web-enabled devices 18 (e.g. a smart-phone, tablet, notebook, or the like computing device) that provides for exchange of VQ data 20 back to the VQ system 30 across firewall 70.

VQ system 30 may comprise one or more of a server, database, and application software that further includes functionality to interface with a Biomaterial Tracking and Management System (BTM) 40 (such as, but not limited to, management software provided by Daedalus Software, Inc.) for the transfer of data 46 relating to automated collection, processing, storage, annotation, and distribution of biosamples 42, 44 and subject data 46 performed by BTM 40 using standard workflow procedures at a given research center. Physicians, administrators 34 also interact with VQ system 30 via a web interface 32, and researchers 54 may also interact with VQ system 30 via web interface 52. The system 10 may also include a data warehouse 50 to serve as a platform for research patient registries 56. Data warehouse 50 may comprise one or more of a server, database, and application software comprising an i2b2 platform that includes the ability to view clinical data in a web-based form (similar to a chart review), enter data directly into warehouse 50, and run reports and perform other visualizations. Additional programs may also be implemented between physician interface 32 and data warehouse 50, including Clarity Relational Structure 60 and CareConnect interface 62.

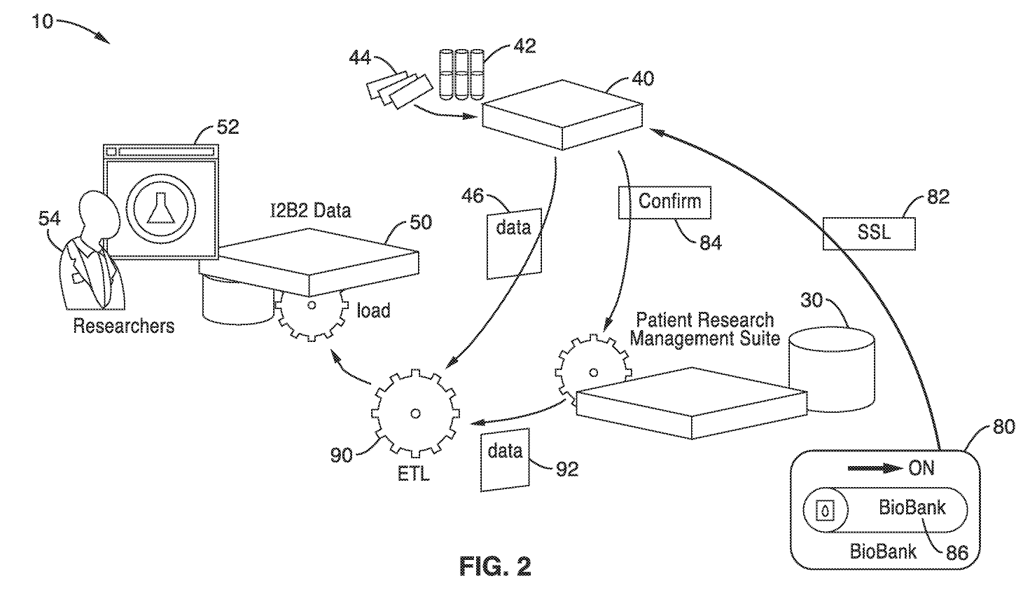

Referring to FIG. 2, when a patient has consented to participate in the biobanking component of the VQ program, a biobank switch 80 in the VQ system 30 will be turned on. This action will trigger an encrypted message 82 to be sent via secure sockets layer (SSL) to BTM 40. In return, the BTM will respond with a status indicator (new patient record created, or patient exists) and the BTM participant ID 84. The VQ system 30 will store this information for later use when a physician 34 or other authorized healthcare user of the VQ system 30 clicks on the bio bank summary icon 86. This action will result in opening a page in a new browser window to a summary of samples cataloged in BTM 40 for a particular patient in relation to this collection protocol. ETL (extract transfer load) module 90 may be used to collect data 92 from VQ system 30 and data 46 from BTM 30, and transform the data according to set business rules/needs and load the data into a destination database.

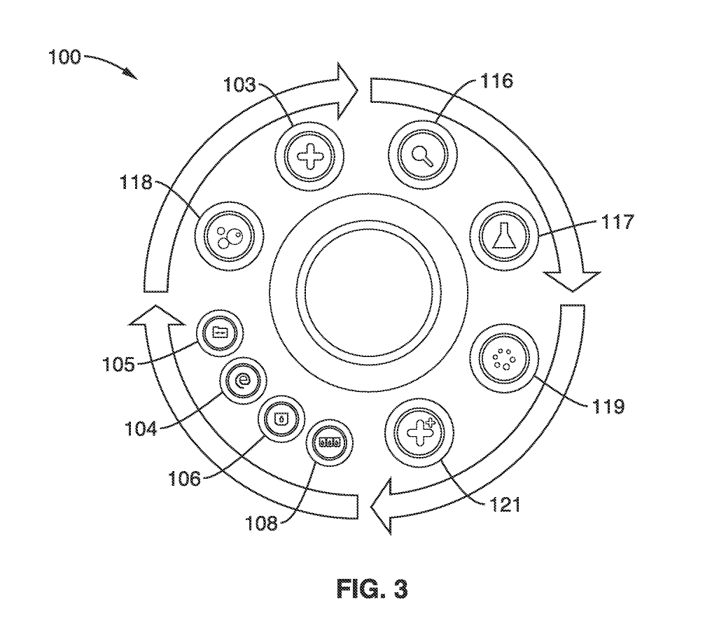

VQ system 30 comprises a server and/or processor along with memory for storing one or more application software modules for determining the value quotient and tight control scenarios detailed in FIG. 3 through FIG. 6 and FIG. 8 through FIG. 14, as described in further detail below.

The Value Quotient (VQ) is a novel aspect of the present disclosure that captures the value of healthcare services to individual patients over time and correlates this with its associated costs (both direct and indirect costs). VQ can be calculated according to Eq. 1:

Value Quotient (VQ)=value/cost Eq. 1

Being a quotient, the numerator of the VQ represents individual Patient Value. The VQ denominator represents the costs per unit of value.

For chronic diseases, Patient Value is defined as a combination of: disease control, Quality of Life, and (Work) Productivity. Under these assumptions, Eq. 1 can now be calculated as Eq. 2:

$$VQ = \frac{[ Disease control ] [ Quality of life ] [ Work productivity ]}{[ Cost ]} \qquad Eq . 2$$

In order to provide monitoring and constant improvement of the value-quotient, a tight control (TC) infrastructure is preferably implemented that incorporates user friendly annual care scenarios in which patients participate. On a macro-level, the TC infrastructure includes programs and support systems configured to iteratively enhance the VQ; on a micro-level this involves the tight control care scenarios for the daily care delivery.

FIG. 3 shows an exemplary macro diagram of TC infrastructure 100 components. TC infrastructure 100 six programs in the areas of care delivery (stem cell center 118, care programs 103), research (trial center 116), research programs 117, and education (fellowship program 119, nursing education 121). In addition, four support systems have been developed, including a disease specific data warehouse 105, eLearning modules 104 for patients, nurses and doctors, biobanks 106 and a platform for systems biology 108. It is appreciated that the above-listed programs are an exemplary list only, and is not meant to be comprehensive.

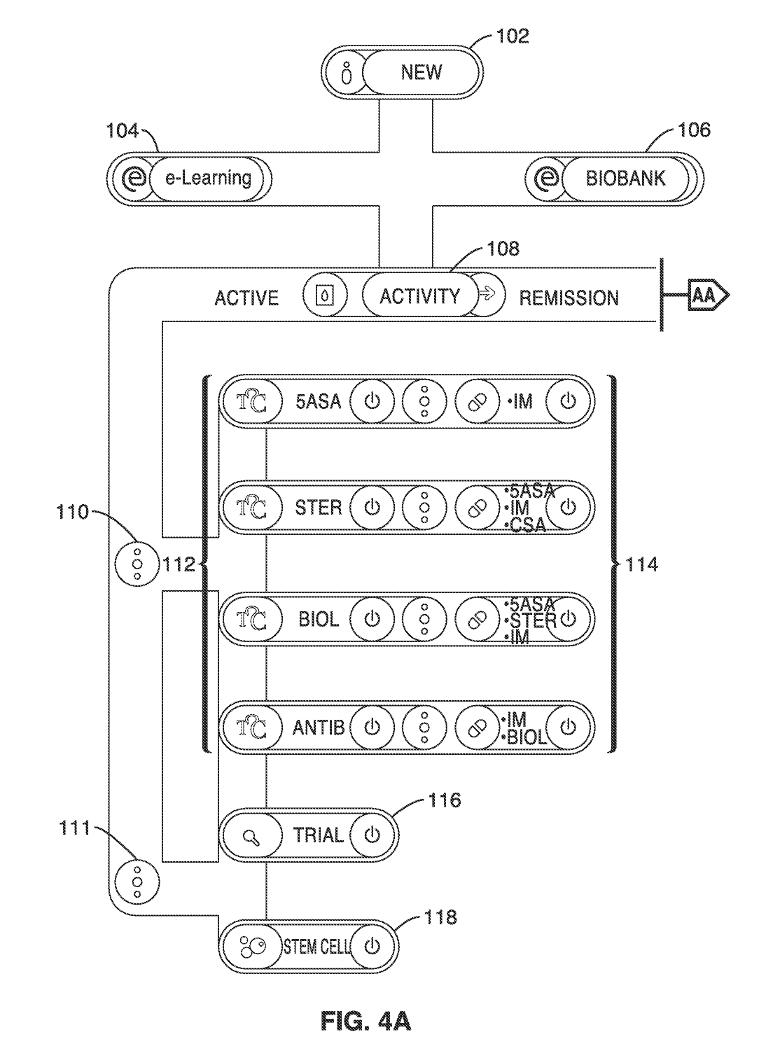

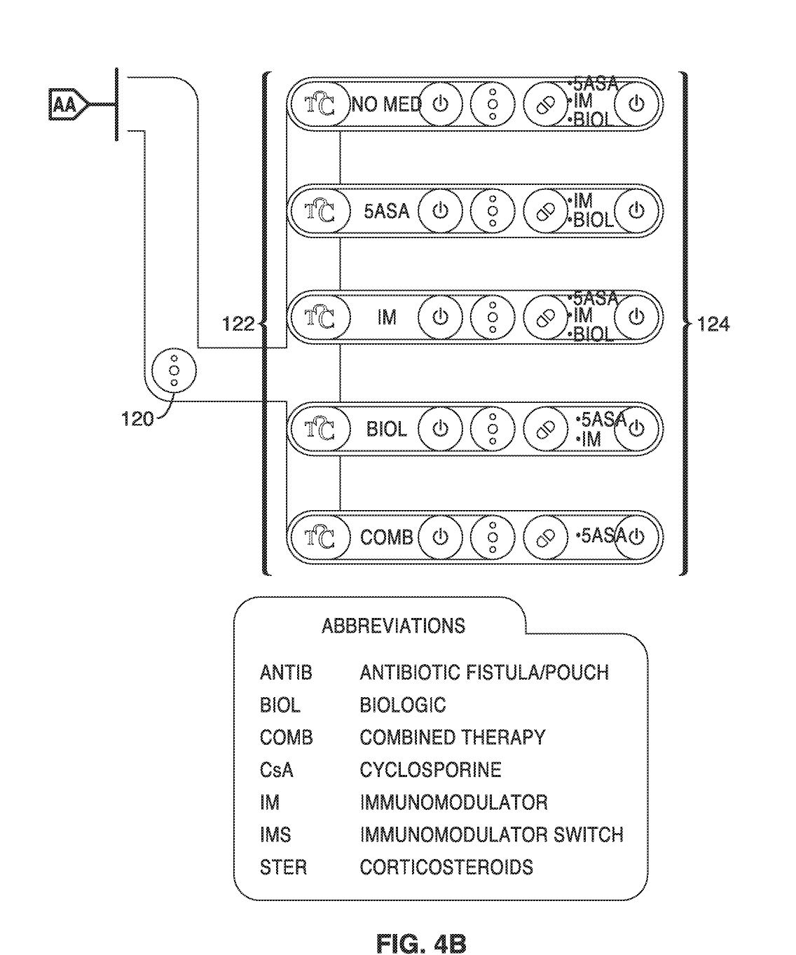

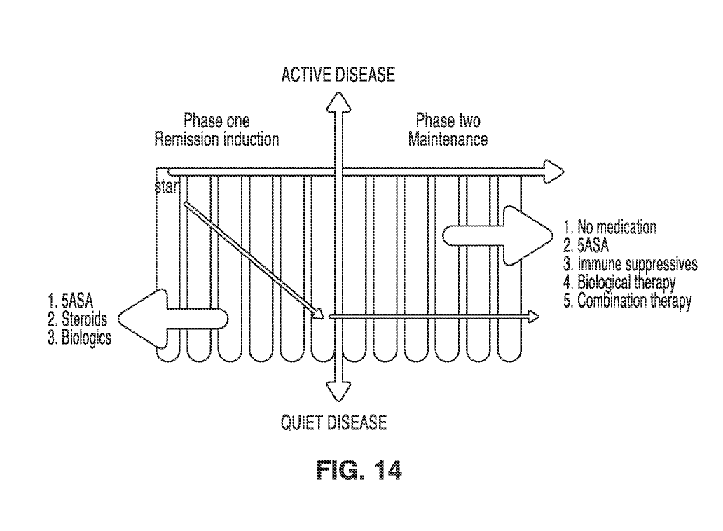

FIG. 4A and FIG. 4B show a schematic diagram of a graphical user interface and decision flow chart of the TC infrastructure 100. FIG. 4 through FIG. 6, and FIG. 8 though FIG. 14, along with the description below, show an exemplary infrastructure for the specific application of Inflammatory Bowel Diseases (IBD's). IBD's are chronic inflammatory diseases of the digestive tract, and include Crohn's disease and ulcerative colitis. Crohn's disease can occur anywhere from mouth to anus, ulcerative colitis typically occurs in the rectum (proctitis), the left-side of the large bowel, or the entire large bowel. It is appreciated that while the systems and methods are particularly well suited for application with IBD's, any number of patient applications are contemplated, and the systems and methods described herein may be modified and/or adapted to various patient conditions.

Instead of finding out how patients are doing during their clinic visits (i.e. a static snapshot model), the tight control infrastructure of the present description continuously captures information on a patient's VQ (i.e. burden of disease, quality of life and work productivity) using a homecare program (i.e. a dynamic model) that generates a much more valuable dataset (e.g. VQ data 20 in FIG. 1) and decision support for direct intervention when needed.

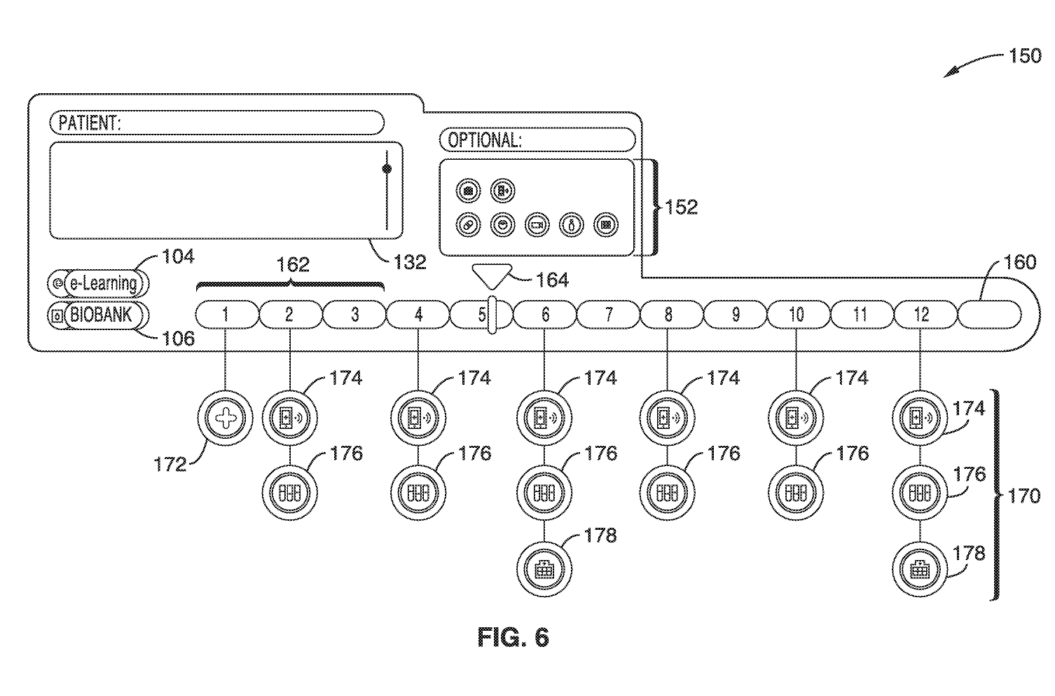

Referring to FIG. 4A, after successful training, a new patient 102 may participate by entering specified datasets (clinical and laboratory outcomes) via flow chart 150 (see FIG. 6) on dedicated tablets or PCs 18 (see FIG. 1). Instant feedback is given and on-demand eConsulting may be offered by nurse specialists. Periodically patients interact personally with their doctor and their assigned nurse specialist to evaluate or discuss strategy choices.

New patients 102 are educated about the disease and the care process (eLearning switch 104), and they can also contribute to high quality biobanks 106.

Depending of their disease activity, patients may be placed into remission/induction or maintenance scenarios by use of the activity switch 108 (shown in the remission scenario in FIG. 4A). At decision junction 110, a variety of active tight control scenario switches 112 corresponding to treatment options are available, in addition to respective medication switches 114.

Referring now to FIG. 4B, at decision junction 120, a variety of remission tight control scenario switches 122 corresponding to remission treatment options are available, in addition to respective medication switches 124.

Furthermore, at decision junction 111 patients may participate in trials at switch 116, stem cell treatments (e.g. for patients with refractory disease) at switch 118, or the like cutting-edge options, if available. As shown in FIG. 4A and FIG. 4B, all tight control scenarios and medication switches for both active and remission states are shown in the off state.

Under the trial programs 116, various types of studies may include: 1) investigator initiated studies, which comprise trials that are configured to study the safety, efficacy or cost-effectiveness of medication or medical decision making; and 2) the industry sponsored studies, which comprise trials offered by the biomedical industry evaluating new compounds for the treatment of inflammatory bowel diseases. Outcomes of these trials will allow refinement of therapeutic strategies in a way to rigorously improve the VQ of individual patients.

Trials may also be conducted for the following studies:

1) Outcome measurements for continuous advancement of instruments for measuring health and well-being from the patient's point of view (e.g. further refinement of the Value Quotient and evaluating VQ driven care against standard hospital care.

2) Classification for personalized therapy will be tailored according to highly specific patient profiles to fully profile individual patients (e.g. genetically, serologically) and correlate this with disease outcome and intensity of treatment.

3) Personalized treatments that follow patients in individual treatment scenarios and determine the optimal safety and efficacy strategies (e.g. via comparator studies between drug classes and various treatment scenarios, and cost-effective optimization of optimal VQ scores per patient profile).

4) Easy-connect systems to develop IT technologies and various user friendly homecare devices in order to ease the burden of patient care and avoid hospital visits. Studies will focus on accuracy of these systems as well as user friendliness and patient satisfaction.

5) Non-hypothesis research. Traditionally, scientific research is hypothesis-driven, seeking to address a specific, measurable, and answerable question. Since the data warehouses of the present disclosure will store gigantic amounts of valuable datasets about all aspects of the disease (genetic, serological, cellular, clinical), new types of business-intelligence research will be possible. For instance, pattern recognition tools may be implemented to scan all existing data marts. New and unexpected disease patterns will thus be discovered and correlations will be found which will shed new light on the disease and its optimal management.

With respect to the stem cell program 118, a significant number of IBD patients suffer from terrible disease activity, poorly responding to traditional medication. Typically, these patients have a hopeless outlook, faced with prolonged hospitalization and repeat surgery only to achieve short term disease control. The health care systems and methods of the present disclosure provide alternative options using two types of stem cell therapy approaches in order to ‘repair’ the immune system: 1) hematopoietic stem cell transplantation; and 2) mesenchymal stem cell treatment. Hematopoietic stem cells are cells capable of differentiating into any of the formed blood elements including white blood cells which represent our immune system. Mesenchymal cells are multipotent ‘connective tissue’ cells that can differentiate into a variety of supportive cell types and are thought to both reduce inflammation and help with wound healing. These natural healing cells have the potential to serve as a repair system for specific inflammatory responses observed in IBD. Both therapeutic strategies hold great promise for refractory inflammatory bowel disease given the growing body of research that has demonstrated feasibility, safety and remarkable efficacy. These programs should not be confused embryonic stem cell programs.

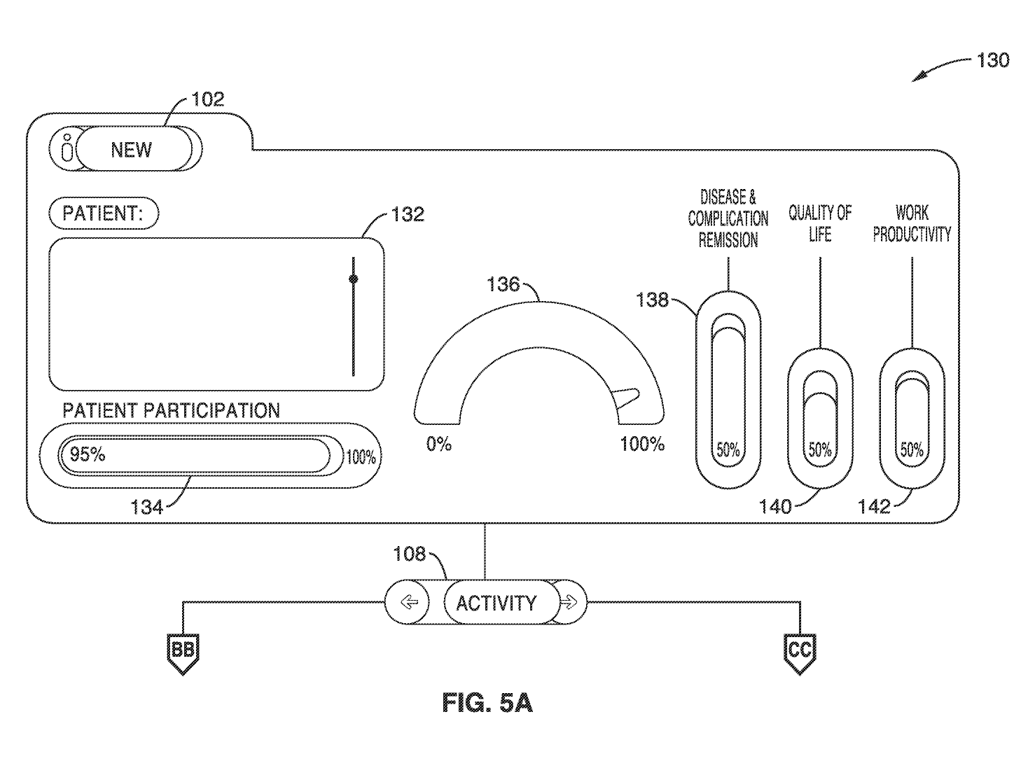

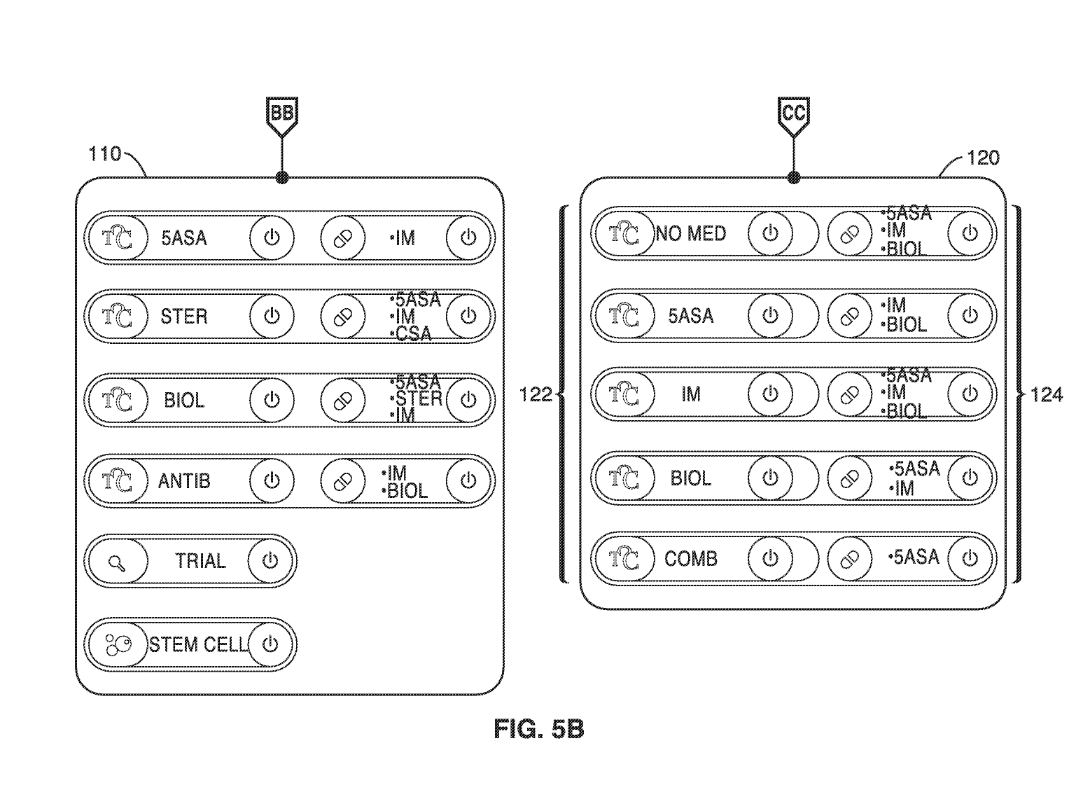

FIG. 5A and FIG. 5B show an exemplary screen view of a patient dashboard 130 that may be implemented at patient interface 16 (see FIG. 1) in accordance with the present disclosure. Dashboard 130 provides an interface for inputting data and information (e.g. via information field 132) for generation and monitoring of individual patient VQs. As the VQ is the quantifiable sum of parameters for 1) disease control, 2) quality of life, and 3) work productivity, status bars 138, 140 and 142 respectively are provided for numerically representing these parameters. VQ gauge 136 provides an overall representation of the VQ values for the patient.

A patient participation status bar 134 may also be included within dashboard 130. Patient participation may be calculated as a function of successful eLearning as well as by patient adherence to the care program. Participation >80% will generally lead to health insurance benefit.

Activity switch 108 and active and remission tight control scenarios 110 and 120 may also be included. As each tight control care scenario is a standardized treatment pathway for a defined period during which all participants contribute, data on disease activity, disease complications, quality of life, work productivity, process performance and associated costs may be repetitively captured and processed into decision support for participants by the data warehouse 50 (see FIG. 1). FIG. 5A and FIG. 5B show the remission TC scenarios 120 activated, with the IM care scenario and Ns each selected from the remission TC scenario switches 122 and remission medication switches 124 selected, respectively.

FIG. 6 shows an exemplary screen view of a daily clinical practice dashboard 150 that may be implemented at physician interface 34 (see FIG. 1) in accordance with the present disclosure. Dashboard 150 provides an interface for inputting data and information (e.g. via information field 132) for generation and monitoring of individual patient VQs. Each patient 102 may be educated over a set period by completing accredited eLearning modules 104. Furthermore, biomaterial may be collected and stored in dedicated biobanks 106. Analyses may be done on the platform for systems biology 108 (see FIG. 3).

During the full cycle of the tight control scenario, optional care procedures 152 are allowed. Should patients experience new symptoms, immediate visits can be scheduled. Results are translated back to the TC scenarios and contribute to VQ improvement and cost reduction.

A timeline bar 160 showing individual intervals 162 (e.g. monthly) and indicator 164 for the current date. Care assessment icons 170 are coupled to the timeline bar 160, with tight control assessment 174 being performed every specified period (e.g. 8 weeks as shown in FIG. 6) using homecare interface 16 and devices 18, where patients participate by entering specific datasets. Instant feedback (including VQ) may be given and on-demand eConsulting is offered by nurse specialists. Periodically, patients may interact with their doctor to evaluate or discuss strategy choices. Care programs 172 may be initiated at the first month, with contemporaneous lab work 176. Periodic clinic visits 178 are also shown scheduled.

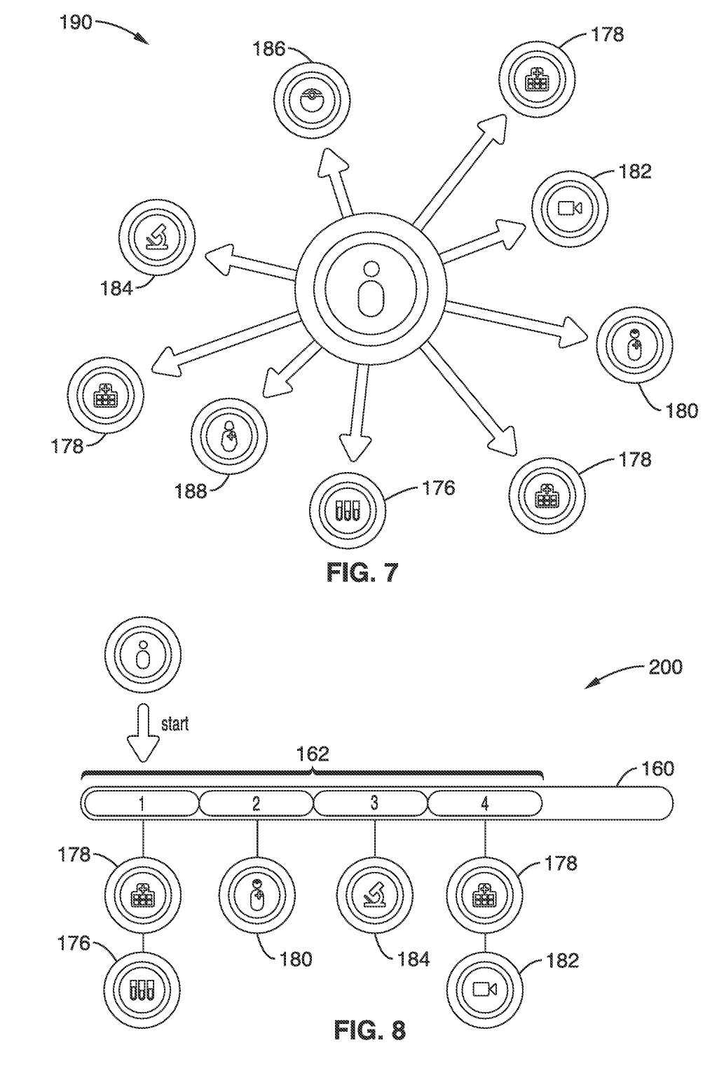

FIG. 7 shows a schematic diagram of typical segmented care 190, where care is sporadically delivered in various forms (e.g. specialist 186, imaging 182 (e.g. endoscopy) pathology 184, nurse 188, clinic visits 178, lab work 176 and other services 180.

In contrast, FIG. 8 shows a tight control care program 200 in accordance with the present disclosure having an organized and coordinated care pathway 160 for care programs among four intervals 162 (e.g. monthly periods) for care services 176, 178, 180, 182, 184. Some additional services 180 may include expert opinion services, eMonitoring services, etc.).

Expert Opinion Services may comprise second opinion services offered by a team of experts to establish an accurate diagnosis, the present state of illness, and the optimal long term therapeutic strategy. Patients may visit the clinic for a full work-up, analyses, evaluation and reporting.

eMonitoring Services are eHealth services offered to assist physicians in tightly monitoring and controlling the disease activity of their patients. System 10 will capture, analyze and report back on individual patient outcomes, and offer decision support as well as on demand eConsulting.

The tight control care system and methods of the present disclosure provide a number of advantages and benefits:

1. Patient education: well-informed, educated and trained patients have been shown to feel less anxious, more in control and interestingly also requiring less tests and procedures. This type of engagement significantly drives empowerment and treatment compliance.

2. Immediate intervention (prevention): the decision support systems dynamically guide healthcare providers and necessary care is delivered immediately, avoiding unnecessary care and costs.

3. Eliminating ineffective care: quite uniquely, care delivery is harmonized among all participating providers using the tight control scenarios detailed above. Optional procedures are allowed by individual physicians, but if not effective (i.e. increase in VQ) will generally not be allowed in the following cycle of care (self-improving system). Expensive drugs will go through central indication and approval process before administration.

4. Task differentiation: more than 80% of this type of preventative care consists of monitoring individual patients. This is performed by nurse specialists instead of physicians. In IBD, each nurse is the ‘health manager’ of approximately 150 patients. In turn, one physician supervises approximately 3 nurses and therefore has the medical responsibility for 450 patients.

5. Reducing administration: patients will participate in data-entry, and thus redundancy of data collection is eliminated; data traffic is fully digitized; and data analysis and reporting is automated.

6. Removal of approvals, claims and reimbursements: an annual ‘value payment’ per disease severity class (mild, moderate or severe) will be allocated including all scenario activities. At the end of each year, revenues are divided among participants (including patients with premium reduction or rebate for those with >80% participation in Homecare and eLearning)

7. De-escalation of patients into lower and less costly disease severity classes: put simply, patients will be less sick and therefore less costly. Many examples have shown that the introduction of compensation for patient participation and homecare on one hand, and strong decision support for providers on the other hand, will dramatically impact and reduce the need for hospital visits and medication.

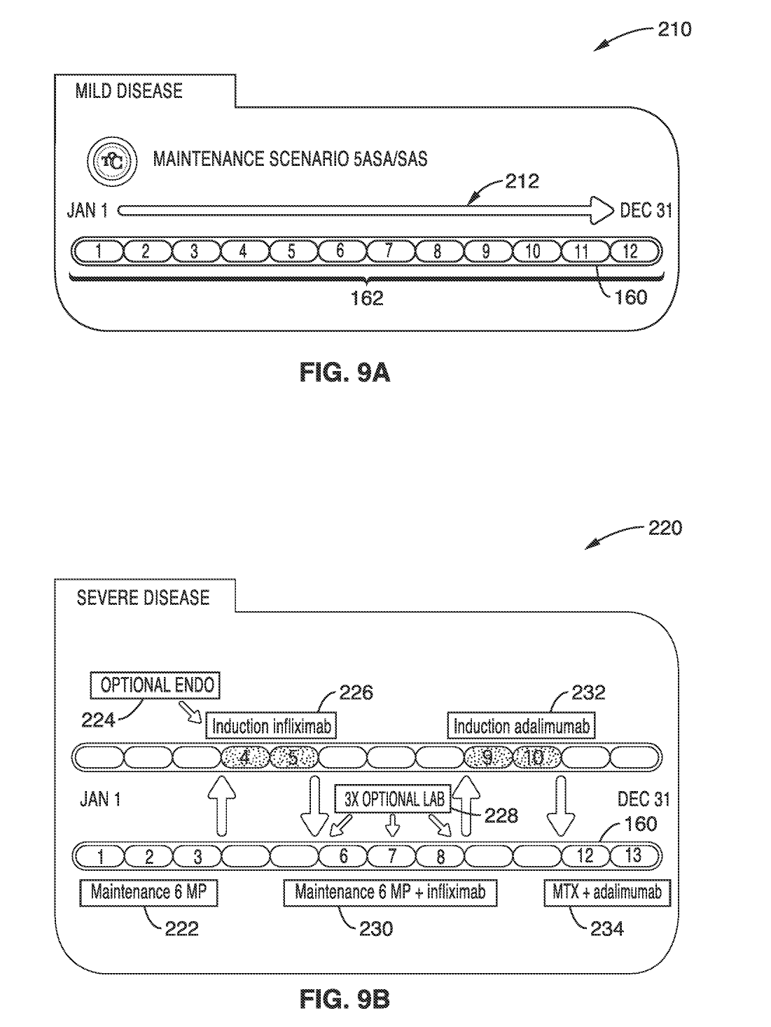

FIG. 9A and FIG. 9B show tight control scenarios for mild disease and severe disease cases respectively. As shown in FIG. 9A, the tight control scenario 210 de-escalates patients into less severe outcomes, e.g. with a constant maintenance scenario (5ASA/SAS) 212 along timeline 160.

In severe disease scenario 220 shown in FIG. 9B, timeline 160 may alternate between maintenance care options 222 (maintenance 6 MP), 230 (maintenance 6 MP+infliximab), 234 (maintenance 6 MP+adalimumab) and induction care options 226 (infliximab), 232 (induction adalimumab).

As shown in FIG. 9A and FIG. 9B, depending on their disease severity (e.g. mild, moderate or severe) patients may experience disease relapse and thus can change treatment scenarios. Furthermore, optional (unforeseen) activities and procedures (e.g. endoscopy 224, laboratory 228) may need to be accounted for especially in the more severe disease class.

The tight control care scenarios of the present disclosure monitor and check patients to avoid unnecessary clinic visits, reduce the number of visits to other physicians, decrease the amount of tests and procedures, detect ‘smoldering’ disease activity (active disease not yet causing symptoms yet), immediately respond upon alarming symptoms, increase drug compliance, and decrease anxiety and depression.

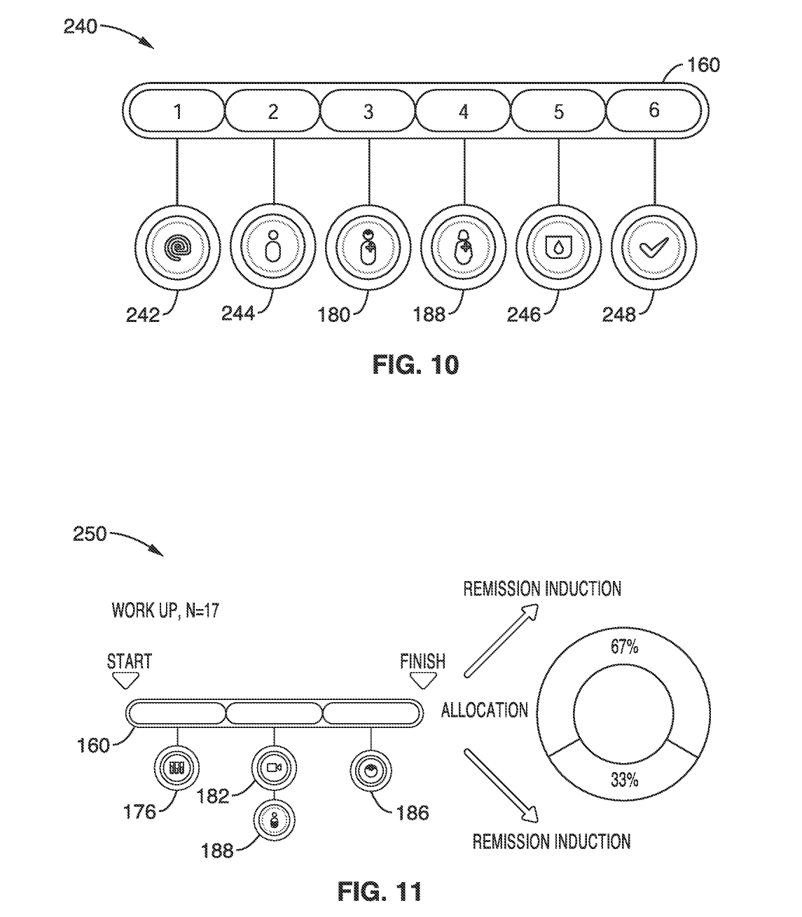

FIG. 10 illustrates a schematic diagram of an exemplary care scenario 240 for a clinic visit in accordance with the present disclosure. Timeline 240 may include services such as eLearning 242, administration 244, nurse station 180, IBD nurse 188, biobank 246, and research nurse 248.

FIG. 11 shows a schematic diagram of a work up scenario 250 and corresponding selection of tight control scenario. Scenario 250 includes laboratory work 176, imaging 182, IBD nurse 188 and specialist 186. New IBD patients can't always immediately be allocated to a tight control scenario because it is not always clear whether the disease is active or not. In one study, a total 17 of 126 patients (13%) in this first cohort required initial diagnostic tests and procedures.

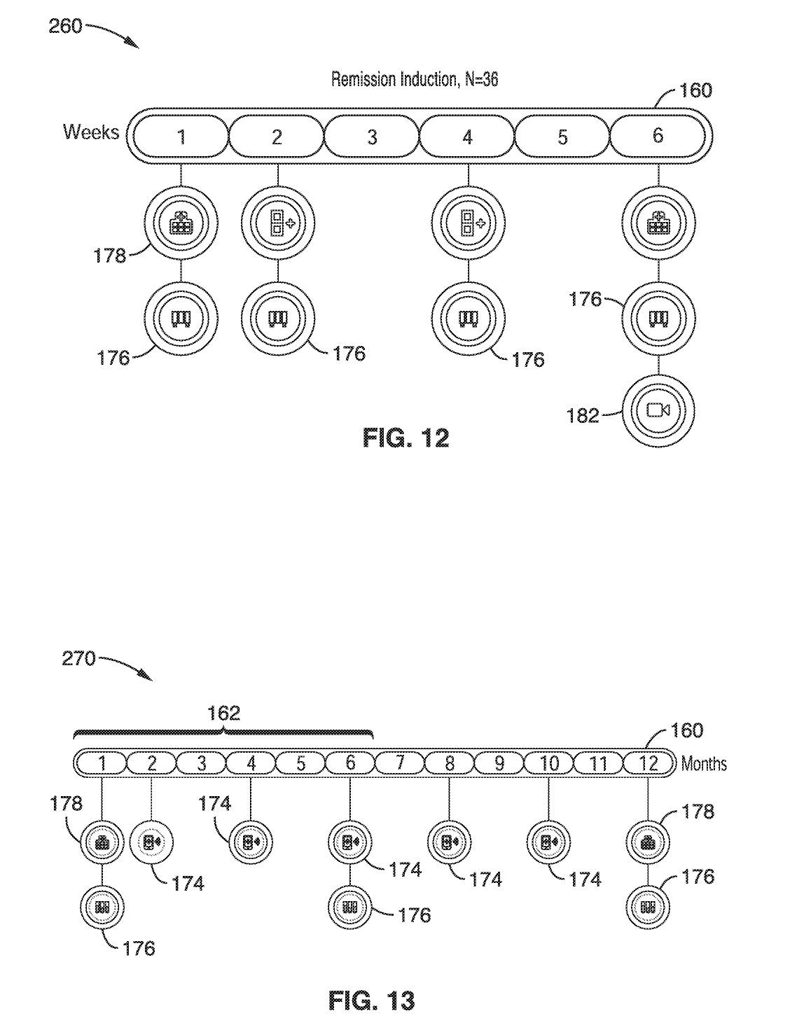

FIG. 12 shows a schematic diagram of an exemplary remission induction tight control scenario 260. Scenario 260 includes clinic visits 178, laboratory work 176, and imaging 182. When allocated to a remission induction scenario, it means that the disease is active and the patient needs anti-inflammatory medication. In one study, a total of 30 out of 36 patients (83%) completed their remission induction scenario successfully and were rolled over to their maintenance scenario.

FIG. 13 is a schematic diagram of an exemplary maintenance tight control scenario 270. Scenario 270 includes clinic visits 178, laboratory work 176, and tight control assessment 174.

Studies were performed to evaluate the first trends of the VQ process in the various tight control scenarios. FIG. 14 shows a diagram of an overview of the tight control scenario in which the VQ's were assessed. It should be appreciated that these are only initial observations limited to 126 patients. Also, the VQ in this phase of the program is defined as a composition of disease control (60%), quality of life (20%) and productivity (20%).

The full cycle of care was defined as one year, which means that at the end of each year, the VQ will have been over the previous 12 months for each individual patient together with the associated costs, along with an overview of factors that negatively influence individual VQ scores. This will beneficially generate personalized improvement strategies and significantly propel our mission to annually improve individual VQ scores. At the end of each cycle, patients and other direct participants (doctors, nurses, and insurer) create the strategic plan for the next twelve months, focusing on improvement of those factors in order to increase the value and decrease associated costs.

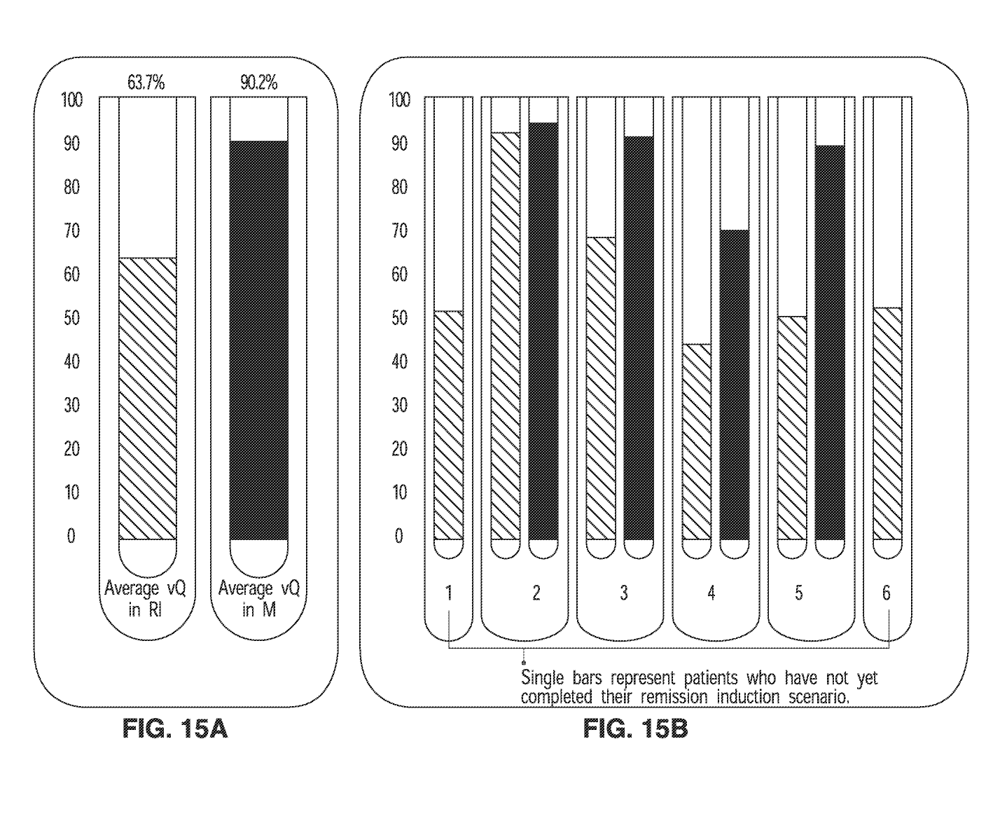

FIG. 15A and FIG. 15B are plots of VQ performance in active patients entering the remission induction (5ASA) scenario. FIG. 15A shows the average VQ's during the remission induction phase, and also the VQ's of their subsequent maintenance phase. FIG. 15B shows the individual patient changes.

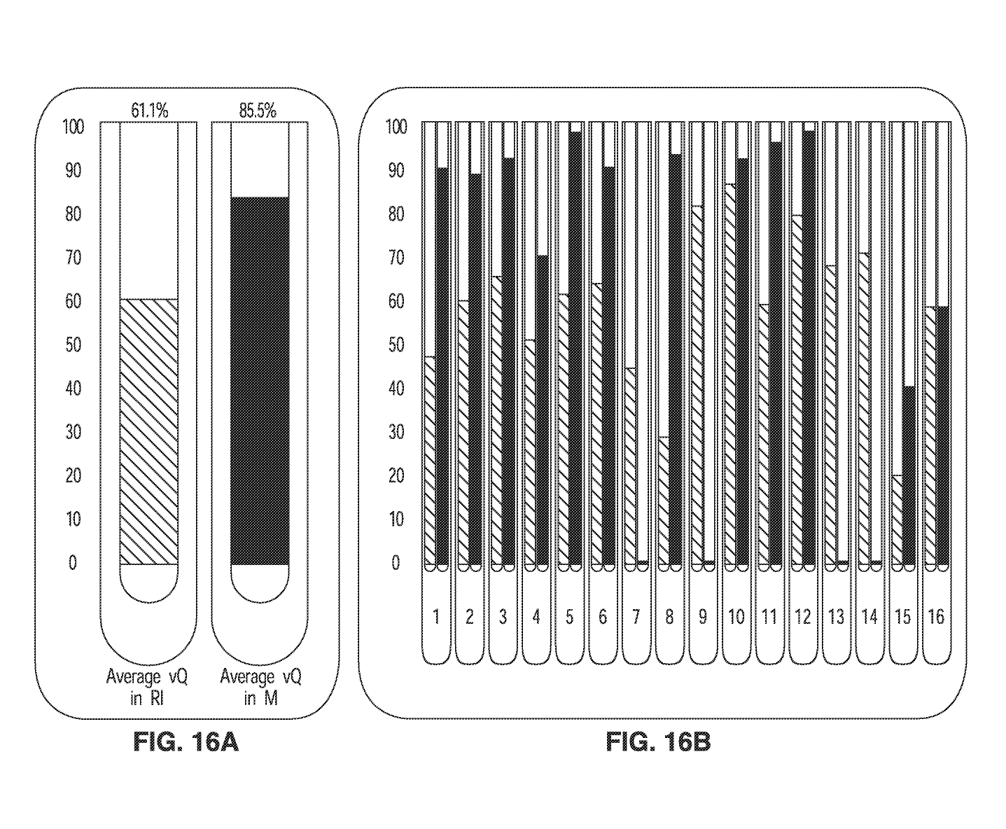

FIG. 16A and FIG. 16B are plots of VQ performance in active patients entering the remission induction (steroid) scenario. FIG. 16A shows the average VQ's during the remission induction phase, and also the VQ's of their subsequent maintenance phase. FIG. 16B shows the individual patient changes.

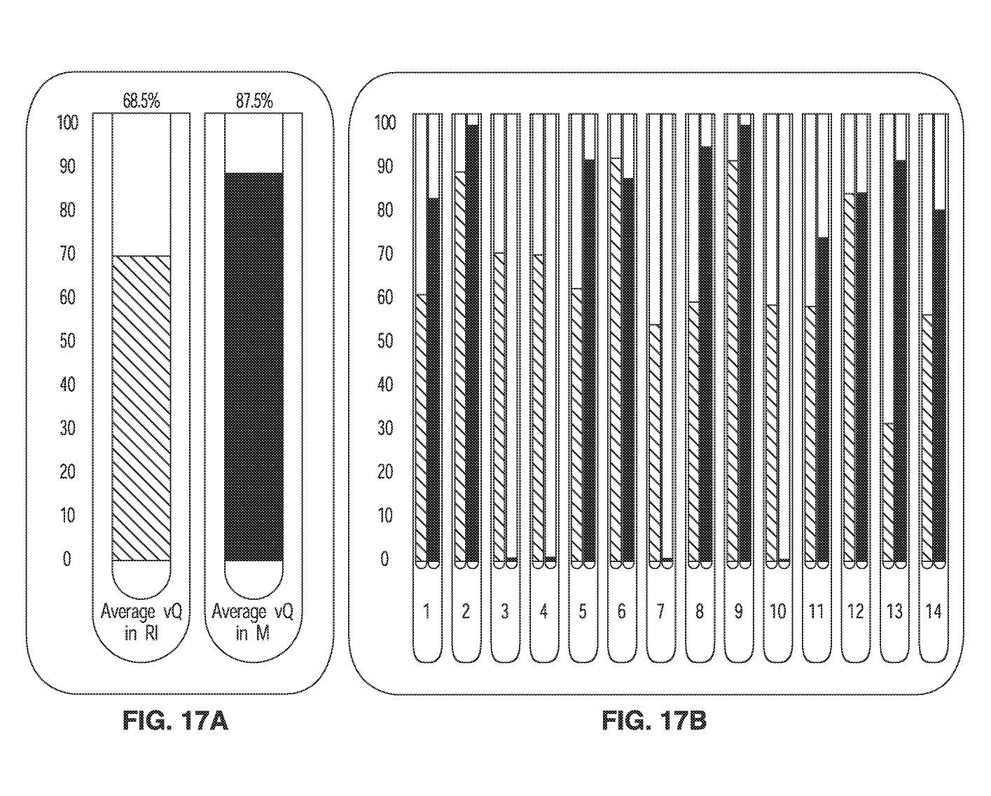

FIG. 17A and FIG. 17B are plots of VQ performance in active patients entering the remission induction (biologics) scenario. FIG. 17A shows the average VQ's during the remission induction phase, and also the VQ's of their subsequent maintenance phase. FIG. 17B shows the individual patient changes.

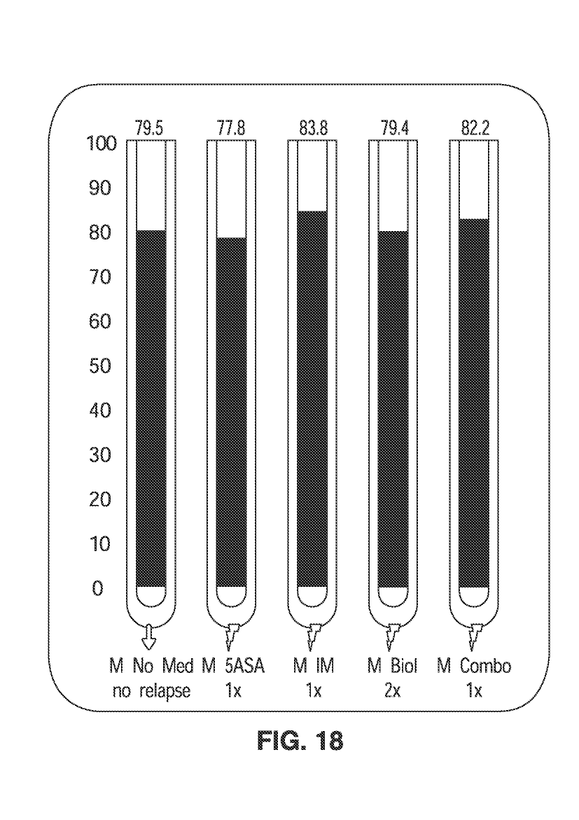

FIG. 18 is a graph of VQ performance in remissive patients in maintenance scenarios. After a robust clinical remission has been achieved, patients exit their remission induction phase and enter a maintenance phase. FIG. 18 shows the average VQ's during their respective maintenance therapy. It also demonstrates the number of relapses during the observation period (range 2-9 months).

Support and add-on systems and services may include one or more of the following features: (a) Disease specific data warehouse, (b) Biobanks, (c) Platform for systems biology, (d) eLearning modules, (e) Accelerated Homecare Technology, (f) Lab-on-a-Chip, (g) Expert Opinion Services, and (h) eMonitoring Services.

In various embodiments, the healthcare systems and methods of the present disclosure may be implemented as collection of programs that provide for management of patient care and research using a combination of value-based methodology and translational research methodology. The software is designed to: 1) generate a single outcome measurement: the Value-Quotient (VQ) expressing delivered health value and the associated costs; 2) Build and manage coordinated care pathways (tight control scenarios) aimed at complication prevention and disease control; 3) Direct Task Differentiation for provider teams shifting work load from physicians to trained nurses and admin; 4) Build and manage Value-based Insurance Design to allow quality payment; 5) Manage Home Care, a patient participatory eHealth program offering education, training, mental support, job coaching and rebates for levels of participation; and 6) Integrate Translational Research methodology with care delivery.

Application software for the health care management system of the present disclosure may include one or more of the following features:

1. Single outcome measure for health benefit and associated costs.

2. Highly coordinated and prevention-oriented care pathways.

3. Personalized patient profiles and individualized care scenarios.

4. Task differentiation at provider level.

5. Integrated eHealth solutions for wellness, education, work productivity and nutrition.

6. Shifting from fee for services model to quality payment model.

7. Self-improving system technology.

8. All-in-One and Easy-to-Use solution for patients, providers, managers, scientists and payers.

9. Interaction with existing Electronic Medical Records (EMRs) and Physician Management Software (PMS).

Benefits of the system and method of the present disclosure may include:

1. Immediate Intervention: the decision support systems dynamically guide health care providers, and necessary care is delivered immediately, avoiding unnecessary care and costs.

2. Elimination of ineffective care: quite uniquely, care delivery is harmonized among all participating specialists using the Tight Control Scenarios. Optional procedures are allowed by individual physicians, but if not effective (i.e. increase in VQ) those will not be allowed in the following cycle of care (self-improving system).

3. Introduction of trained nurses: more than 80% of this type of preventative care consists of monitoring individual patients which will be performed by nurse specialists instead of physicians. Each nurse is the ‘account manager’ of 100 patients; each physician oversees 3 nurses and has responsibility for 300 patients.

4. Reduction of administration: patients will participate in data-entry; redundancy of data collection is eliminated; data traffic is fully digitized; data analysis and reporting is automated.

5. Removal of Approvals, Claims and Reimbursements: an annual ‘value payment’ per disease intensity class (mild, moderate or intense) will be allocated including all scenario activities. At the end of each year, revenues are divided among participants (including patients with premium reduction for those with >80% participation in Homecare and eLearning)

6. De-escalation of patients into lower and less costly disease severity class: put simply, patients will be less sick and therefore less costly. Many examples have shown that introducing recompensing patient participation and homecare on one hand, and strong decision support for providers on the other hand, this will dramatically impact and reduce the need for hospital visits and medication.

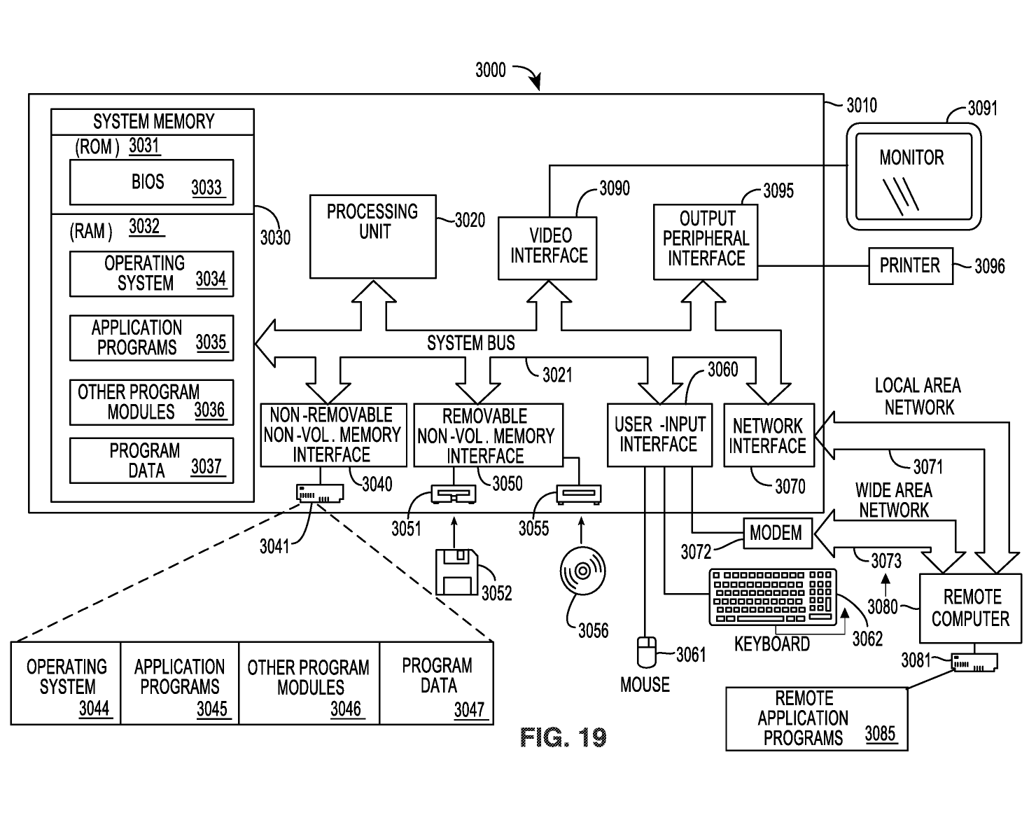

FIG. 19 illustrates an exemplary block diagram of a health care management system 3000 on which the exemplary methods of the described embodiments above may operate. The system 3000 of FIG. 30 includes a computing device in the form of a computer 3010. Components of the computer 3010 may include, and are not limited to, a processing unit 3020, a system memory 3030, and a system bus 3021 that couples various system components including the system memory to the processing unit 3020. The system bus 3021 may be any of several types of bus structures including a memory bus or memory controller, a peripheral bus, and a local bus using any of a variety of bus architectures. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

The computer 3010 typically includes a variety of computer readable media. Computer readable media can be any available media that can be accessed by computer 3010 and includes both volatile and nonvolatile media, and both removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 3010. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of any of the above are also included within the scope of computer readable media.

The system memory 3030 includes computer storage media in the form of volatile and/or nonvolatile memory such as read only memory (ROM) 3031 and random access memory (RAM) 3032. A basic input/output system 3033 (BIOS), containing the basic routines that help to transfer information between elements within computer 3010, such as during start-up, is typically stored in ROM 3031. RAM 3032 typically contains data and/or program modules or routines, e.g., analyzing, calculating, indicating, etc., that are immediately accessible to and/or presently being operated on by processing unit 3020. By way of example, and not limitation, FIG. 19 illustrates operating system 3034, application programs 3035, other program modules 3036, and program data 3037.

The computer 3010 may also include other removable/non-removable, volatile/nonvolatile computer storage media. By way of example only, FIG. 19 illustrates a hard disk drive 3041 that reads from or writes to non-removable, nonvolatile magnetic media, a magnetic disk drive 3051 that reads from or writes to a removable, nonvolatile magnetic disk 3052, and an optical disk drive 3055 that reads from or writes to a removable, nonvolatile optical disk 3056 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 3041 is typically connected to the system bus 3021 through a non-removable memory interface such as interface 3040, and magnetic disk drive 3051 and optical disk drive 3055 are typically connected to the system bus 3021 by a removable memory interface, such as interface 3050.

The drives and their associated computer storage media discussed above and illustrated in FIG. 19 provide storage of computer readable instructions, data structures, program modules and other data for the computer 3010. In FIG. 19, for example, hard disk drive 3041 is illustrated as storing operating system 3044, application programs 3045, other program modules 3046, and program data 3047. Note that these components can either be the same as or different from operating system 3034, application programs 3035, other program modules 3036, and program data 3037. Operating system 3044, application programs 3045, other program modules 3046, and program data 3047 are given different numbers here to illustrate that, at a minimum, they are different copies. A user may enter commands and information into the computer 3010 through input devices such as a keyboard 3062 and cursor control device 3061, commonly referred to as a mouse, trackball or touch pad. A screen 3091 or other type of display device is also connected to the system bus 3021 via an interface, such as a graphics controller 3090. In addition to the screen 3091, computers may also include other peripheral output devices such as printer 3096, which may be connected through an output peripheral interface 3095.

The computer 3010 may operate in a networked environment using logical connections to one or more remote computers, such as a remote computer 3080. The remote computer 3080 may be configured as a patient user interface. The logical connections depicted in FIG. 19 include a local area network (LAN) 3071 and a wide area network (WAN) 3073, but may also include other networks. Such networking environments are commonplace in hospitals, offices, enterprise-wide computer networks, intranets, and the Internet.

When used in a LAN networking environment, the computer 3010 is connected to the LAN 3071 through a network interface or adapter 3070. When used in a WAN networking environment, the computer 3010 typically includes a modem 3072 or other means for establishing communications over the WAN 3073, such as the Internet. The modem 3072, which may be internal or external, may be connected to the system bus 3021 via the input interface 3060, or other appropriate mechanism. In a networked environment, program modules depicted relative to the computer 3010, or portions thereof, may be stored in the remote memory storage device 3081. By way of example, and not limitation, FIG. 19 illustrates remote application programs 3085 as residing on memory device 3081.

The communications connections 3070, 3072 allow the device to communicate with other devices. The communications connections 3070, 3072 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

The embodiments for the methods described above may be implemented in part or in their entirety using one or more computer systems, such as the computer system 3000 illustrated in FIG. 19. The data representative of the information regarding the symptoms, data representative of the information related to the medical condition and data representative of the physician consultation information, database, and/or models may be received by a computer such as the computer 3010, for example. The data representative of the information regarding the symptoms, data representative of the information related to the medical condition and data representative of the physician consultation information, database, and/or models may be received over a communication medium such as local area network 3071 or wide area network 3073, via network interface 3070 or user-input interface 3060, for example. As another example, the data representative of the information regarding the symptoms, data representative of the information related to the medical condition and data representative of the physician consultation information, database, and/or models may be received from a remote source such as the remote computer 3080 where the data is initially stored on memory device such as the memory storage device 3081. As another example, the data representative of the information regarding the symptoms, data representative of the information related to the medical condition and data representative of the physician consultation information, database, and/or models may be received from a removable memory source such as the nonvolatile magnetic disk 3052 or the nonvolatile optical disk 3056. As another example, the data representative of the information regarding the symptoms, data representative of the information related to the medical condition and data representative of the physician consultation information, database, and/or models may be received as a result of a human entering data through an input device such as the keyboard 3062.

Some or all analyzing or calculating performed in the determination of a patient VQ, and/or TC scenarios may be performed by a computer such as the computer 3010, and more specifically may be performed by one or more processors, such as the processing unit 3020, for example. In some embodiments, some calculations may be performed by a first computer such as the computer 3010 while other calculations may be performed by one or more other computers such as the remote computer 3080. The analyses and/or calculations may be performed according to instructions that are part of a program such as the application programs 3035, the application programs 3045 and/or the remote application programs 3085, for example.

Determining a tailored prescription as described above in the embodiments may also be performed by a computer such as the computer 3010. The indications may be made by setting the value of a data field stored in the ROM memory 3031 and/or the RAM memory 3032, for example. In some embodiments, providing an integrated symptom summary to a physician and providing a tailored prescription to a patient may include sending data over a network such as the local area network 3071 or the wide area network 3073 to another computer, such as the remote computer 3081. In other embodiments, providing an integrated symptom summary to a physician and providing a tailored prescription to a patient may include sending data over a video interface such as the video interface 3090 to display information relating to the prediction on an output device such as the screen 3091 or the printer 3096, for example.

Embodiments of the present description may be described with reference to flowchart illustrations of methods and systems according to embodiments of the description, and/or algorithms, formulae, or other computational depictions, which may also be implemented as computer program products. In this regard, each block or step of a flowchart, and combinations of blocks (and/or steps) in a flowchart, algorithm, formula, or computational depiction can be implemented by various means, such as hardware, firmware, and/or software including one or more computer program instructions embodied in computer-readable program code logic. As will be appreciated, any such computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s).

Accordingly, blocks of the flowcharts, algorithms, formulae, or computational depictions support combinations of means for performing the specified functions, combinations of steps for performing the specified functions, and computer program instructions, such as embodied in computer-readable program code logic means, for performing the specified functions. It will also be understood that each block of the flowchart illustrations, algorithms, formulae, or computational depictions and combinations thereof described herein, can be implemented by special purpose hardware-based computer systems which perform the specified functions or steps, or combinations of special purpose hardware and computer-readable program code logic means.

Furthermore, these computer program instructions, such as embodied in computer-readable program code logic, may also be stored in a computer-readable memory that can direct a computer or other programmable processing apparatus to function in a particular manner, such that the instructions stored in the computer-readable memory produce an article of manufacture including instruction means which implement the function specified in the block(s) of the flowchart(s). The computer program instructions may also be loaded onto a computer or other programmable processing apparatus to cause a series of operational steps to be performed on the computer or other programmable processing apparatus to produce a computer-implemented process such that the instructions which execute on the computer or other programmable processing apparatus provide steps for implementing the functions specified in the block(s) of the flowchart(s), algorithm(s), formula(e), or computational depiction(s).

It will further be appreciated that “programming” as used herein refers to one or more instructions that can be executed by a processor to perform a function as described herein. The programming can be embodied in software, in firmware, or in a combination of software and firmware. The programming can be stored local to the device in nontransitory media, or can be stored remotely such as on a server, or all or a portion of the programming can be stored locally and remotely. Programming stored remotely can be downloaded (pushed) to the device by user initiation, or automatically based on one or more factors. It will further be appreciated that as used herein, that the terms processor, central processing unit (CPU), and computer are used synonymously to denote a device capable of executing the programming and communication with input/output interfaces and/or peripheral devices.

From the description herein, it will be appreciated that that the present disclosure encompasses multiple embodiments which include, but are not limited to, the following:

1. A system for managing healthcare for a plurality of patients, comprising: (a) a processor; and (b) programming executable on the processor and configured for: (i) establishing a numerical indicator for a patient value of healthcare services to an individual patient over time; and (ii) correlating the patient value indicator with one or more costs associated with said healthcare services.

2. The system of any preceding embodiment, wherein correlating the patient value indicator comprises dividing the patient value by the costs per unit value to generate a value quotient.

3. The system of any preceding embodiment: wherein the healthcare services are associated with a chronic disease; and wherein the patient value indicator is generated as a combination of one or more of: patient disease control, patient quality of life, and patient productivity with respect to the healthcare services.

4. The system of any preceding embodiment, wherein the patient value indicator is generated as a combination of patient disease control, patient quality of life, and patient productivity.

5. The system of any preceding embodiment, wherein said programming is further configured for generating a standardized treatment pathway for a patient for a defined period based on patient input during said period.

6. The system of any preceding embodiment, wherein said patient input comprises data relating to one or more of: disease activity, disease complications, quality of life, work productivity, process performance and associated costs with respect to said healthcare services.

7. The system of any preceding embodiment, wherein said patient input data is repetitively captured and stored within a database throughout said period.

8. The system of any preceding embodiment, further comprising: one or more patient portals; said one or more patient portals providing a graphical user interface configured to allow said patient to enter said patient input data.

9. The system of any preceding embodiment, wherein the patient input data is used to generate the patient value indicator.

10. The system of any preceding embodiment, wherein said programming is further configured for assigning one or more of a remission induction scenario or maintenance scenario as a function of a patient's disease activity.

11. The system of any preceding embodiment, wherein said programming is further configured for: collecting biomaterial data correlating to said patient and healthcare services; performing analysis on said biomaterial data; and storing said biomaterial data and analysis data in the database; wherein one or more of the biomaterial data or the analysis data are used in generating the patient value indicator.

12. A computer-readable storage medium comprising nontransitory computer-readable instructions stored thereon and to be executed on a processor of a system for automatically managing healthcare for a plurality of patients, said instructions configured for: storing data relating to healthcare services delivered to one or more patients; establishing a numerical indicator for a patient value for one or more of the healthcare services to an individual patient over a period of time; and correlating the patient value indicator with a value corresponding to costs associated with said one or more healthcare services to generate a value quotient; wherein correlating the patient value indicator comprises dividing the patient value by the costs per unit value to generate a value quotient.

13. A computer-readable storage medium as in any of the previous embodiments: wherein the healthcare services are associated with a chronic disease; and wherein the patient value indicator is generated as a combination of one or more of: patient disease control, patient quality of life, and patient productivity with respect to the healthcare services.

14. A computer-readable storage medium as in any of the previous embodiments, wherein the patient value indicator is generated as a combination of patient disease control, patient quality of life, and patient productivity.

15. A computer-readable storage medium as in any of the previous embodiments, wherein said instructions are further configured for generating a standardized treatment pathway for a patient for a defined period based on patient input during said period.

16. A computer-readable storage medium as in any of the previous embodiments, wherein said patient input comprises data relating to one or more of: disease activity, disease complications, quality of life, work productivity, process performance and associated costs with respect to said healthcare services.

17. A computer-readable storage medium as in any of the previous embodiments, wherein said patient input data is repetitively captured and stored within a database throughout said period.

18. A computer-readable storage medium as in any of the previous embodiments, wherein said instructions are further configured for: providing one or more patient portals providing a graphical user interface configured to allow said patient to enter said patient input data.

19. A computer-readable storage medium as in any of the previous embodiments, wherein the patient input data is used to generate the patient value indicator.

20. A computer-readable storage medium as in any of the previous embodiments, wherein said instructions are further configured for: assigning one or more of a remission induction scenario or maintenance scenario as a function of a patient's disease activity.

21. A computer-readable storage medium as in any of the previous embodiments, wherein said instructions are further configured for: collecting biomaterial data correlating to said patient and healthcare services; performing analysis on said biomaterial data; and storing said biomaterial data and analysis data in the database; wherein one or more of the biomaterial data or the analysis data are used in generating the patient value indicator.

22. A system for managing healthcare for a plurality of patients, comprising: (a) a processor; (b) a database configured for storing data relating to healthcare services delivered to one or more patients; and (c) programming executable on the processor and configured for: (i) establishing a numerical indicator for a patient value for one or more of the healthcare services to an individual patient over a period of time; and (ii) dividing the patient value indicator by a value corresponding to costs per unit value associated with said one or more healthcare services to generate a value quotient.

23. The system of any preceding embodiment: wherein the healthcare services are associated with a chronic disease; and wherein the patient value indicator is generated as a combination of one or more of: patient disease control, patient quality of life, and patient productivity with respect to the healthcare services.

24. The system of any preceding embodiment, wherein the patient value indicator is generated as a combination of patient disease control, patient quality of life, and patient productivity.

25. The system of any preceding embodiment, wherein said programming is further configured for generating a standardized treatment pathway for a patient for a defined period based on patient input during said period.

26. The system of any preceding embodiment, wherein said patient input comprises data relating to one or more of: disease activity, disease complications, quality of life, work productivity, process performance and associated costs with respect to said healthcare services.

27. The system of any preceding embodiment, wherein said patient input data is repetitively captured and stored within the database throughout said period.

28. The system of any preceding embodiment, further comprising: one or more patient portals; said one or more patient portals providing a graphical user interface configured to allow said patient to enter said patient input data.

29. The system of any preceding embodiment, wherein the patient input data is used to generate the patient value indicator.

30. The system of any preceding embodiment, wherein said programming is further configured for assigning one or more of a remission induction scenario or maintenance scenario as a function of a patient's disease activity.

31. The system of any preceding embodiment, wherein said programming is further configured for: collecting biomaterial data correlating to said patient and healthcare services; performing analysis on said biomaterial data; and storing said biomaterial data and analysis data in the database; wherein one or more of the biomaterial data or the analysis data are used in generating the patient value indicator.

32. The system of any preceding embodiment, wherein the patient input comprises specified datasets relating to one or more of clinical and laboratory outcomes corresponding to said healthcare services.

33. The system of any preceding embodiment, wherein the graphical user interface comprises a patient dashboard comprising a timeline of the healthcare services.

34. The system of any preceding embodiment: wherein the graphical user interface comprises an activity switch that allows a user to toggle between an active care scenario and a remission control scenario; and wherein the active care scenario and a remission control scenario each have independent care services associated to them.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

In the claims, reference to an element in the singular is not intended to mean “one and only one” unless explicitly so stated, but rather “one or more.” All structural, chemical, and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A system for managing healthcare for a plurality of patients, comprising:
(a) a processor; and
(b) programming executable on the processor and configured to:
(i) establish a numerical indicator for a patient value of healthcare services to an individual patient over time; and
(ii) correlate the patient value indicator with one or more costs associated with said healthcare services.

2. A system as recited in claim 1, wherein correlating the patient value indicator comprises dividing the patient value by the costs per unit value to generate a value quotient.

3. A system as recited in claim 1:
wherein the healthcare services are associated with a chronic disease; and
wherein the patient value indicator is generated as a combination of one or more of: patient disease control, patient quality of life, and patient productivity with respect to the healthcare services.

4. A system as recited in claim 3, wherein the patient value indicator is generated as a combination of patient disease control, patient quality of life, and patient productivity.

5. A system as recited in claim 1, wherein said programming is further configured to generate a standardized treatment pathway for a patient for a defined period based on patient input during said period.

6. A system as recited in claim 5, wherein said patient input comprises data relating to one or more of: disease activity, disease complications, quality of life, work productivity, process performance and associated costs with respect to said healthcare services.

7. A system as recited in claim 6, wherein said patient input data is repetitively captured and stored within a database throughout said period.

8. A system as recited in claim 7, further comprising:
one or more patient portals;
said one or more patient portals providing a graphical user interface configured to allow said patient to enter said patient input data.

9. A system as recited in claim 6, wherein the patient input data is used to generate the patient value indicator.

10. A system as recited in claim 6, wherein said programming is further configured to assign one or more of a remission induction scenario or maintenance scenario as a function of a patient's disease activity.

11. A system as recited in claim 7, wherein said programming is further configured to:
collect biomaterial data correlating to said patient and healthcare services;
perform analysis on said biomaterial data; and
store said biomaterial data and analysis data in the database;
wherein one or more of the biomaterial data or the analysis data are used in generating the patient value indicator.

12. A computer-readable storage medium comprising nontransitory computer-readable instructions stored thereon and to be executed on a processor of a system for automatically managing healthcare for a plurality of patients, said instructions configured to:
store data relating to healthcare services delivered to one or more patients;
establish a numerical indicator for a patient value for one or more of the healthcare services to an individual patient over a period of time; and
correlate the patient value indicator with a value corresponding to costs associated with said one or more healthcare services to generate a value quotient;
wherein correlating the patient value indicator comprises dividing the patient value by the costs per unit value to generate a value quotient.

13. A computer-readable storage medium as recited in claim 12:
wherein the healthcare services are associated with a chronic disease; and
wherein the patient value indicator is generated as a combination of one or more of: patient disease control, patient quality of life, and patient productivity with respect to the healthcare services.

14. A computer-readable storage medium as recited in claim 13, wherein the patient value indicator is generated as a combination of patient disease control, patient quality of life, and patient productivity.

15. A computer-readable storage medium as recited in claim 12, wherein said instructions are further configured to generate a standardized treatment pathway for a patient for a defined period based on patient input during said period.

16. A computer-readable storage medium as recited in claim 15, wherein said patient input comprises data relating to one or more of: disease activity, disease complications, quality of life, work productivity, process performance and associated costs with respect to said healthcare services.

17. A computer-readable storage medium as recited in claim 16, wherein said patient input data is repetitively captured and stored within a database throughout said period.

18. A computer-readable storage medium as recited in claim 17, wherein said instructions are further configured to provide one or more patient portals providing a graphical user interface configured to allow said patient to enter said patient input data.

19. A computer-readable storage medium as recited in claim 16, wherein the patient input data is used to generate the patient value indicator.

20. A computer-readable storage medium as recited in claim 16, wherein said instructions are further configured to assign one or more of a remission induction scenario or maintenance scenario as a function of a patient's disease activity.

21. A computer-readable storage medium as recited in claim 17, wherein said instructions are further configured to:
collect biomaterial data correlating to said patient and healthcare services;
perform analysis on said biomaterial data; and
store said biomaterial data and analysis data in the database;
wherein one or more of the biomaterial data or the analysis data are used in generating the patient value indicator.

22. A system for managing healthcare for a plurality of patients, comprising:
(a) a processor;
(b) a database configured to store data relating to healthcare services delivered to one or more patients; and
(c) programming executable on the processor and configured to:
(i) establish a numerical indicator for a patient value for one or more of the healthcare services to an individual patient over a period of time; and
(ii) divide the patient value indicator by a value corresponding to costs per unit value associated with said one or more healthcare services to generate a value quotient.

23. A system as recited in claim 22:
wherein the healthcare services are associated with a chronic disease; and
wherein the patient value indicator is generated as a combination of one or more of: patient disease control, patient quality of life, and patient productivity with respect to the healthcare services.

24. A system as recited in claim 22, wherein the patient value indicator is generated as a combination of patient disease control, patient quality of life, and patient productivity.

25. A system as recited in claim 22, wherein said programming is further configured to generate a standardized treatment pathway for a patient for a defined period based on patient input during said period.

26. A system as recited in claim 25, wherein said patient input comprises data relating to one or more of: disease activity, disease complications, quality of life, work productivity, process performance and associated costs with respect to said healthcare services.

27. A system as recited in claim 26, wherein said patient input data is repetitively captured and stored within the database throughout said period.

28. A system as recited in claim 27, further comprising:
one or more patient portals;
said one or more patient portals providing a graphical user interface configured to allow said patient to enter said patient input data.

29. A system as recited in claim 26, wherein the patient input data is used to generate the patient value indicator.

30. A system as recited in claim 26, wherein said programming is further configured to assign one or more of a remission induction scenario or maintenance scenario as a function of a patient's disease activity.

31. A system as recited in claim 27, wherein said programming is further configured to:
collect biomaterial data correlating to said patient and healthcare services;
perform analysis on said biomaterial data; and
store said biomaterial data and analysis data in the database;
wherein one or more of the biomaterial data or the analysis data are used in generating the patient value indicator.

32. A system as recited in claim 26, wherein the patient input comprises specified datasets relating to one or more of clinical and laboratory outcomes corresponding to said healthcare services.

33. A system as recited in claim 28, wherein the graphical user interface comprises a patient dashboard comprising a timeline of the healthcare services.

34. A system as recited in claim 33:
wherein the graphical user interface comprises an activity switch that allows a user to toggle between an active care scenario and a remission control scenario; and
wherein the active care scenario and a remission control scenario each have independent care services associated to them.
